(19) United States
(12) Patent Application Publication
(10) Pub. No.: US 2022/0270503 A1
(43) Pub. Date: Aug. 25, 2022

(54) PRONUNCIATION ASSESSMENT WITH DYNAMIC FEEDBACK

(71) Applicant: Speak2Go Ltd., Oranit (IL)

(72) Inventor: Kfir Adam, Oranit (IL)

(21) Appl. No.: 17/676,156

(22) Filed: Feb. 20, 2022

(30) Foreign Application Priority Data
Feb. 23, 2021 (IL) 281064

(51) Int. Cl. G09B 5/06; G10L 15/02; G10L 15/22

(52) U.S. Cl. CPC G09B 5/065; G10L 15/02; G10L 15/22; G10L 2015/025; G10L 2015/221; G10L 2015/225

(57) ABSTRACT

Dynamic, personalized and adaptive feedback during pronunciation assessment of a non-native language. Multiple utterances are first input to a trained machine including multiple instances of a phoneme. The instances of the phoneme are processed and a base level of proficiency is determined for sounding the phoneme. A second instance of the phoneme is input and feedback is presented responsive for the current level of proficiency for sounding the phoneme relative to the base level of proficiency. Then, the current level of proficiency for sounding the phoneme is determined considering the level of proficiency of the second instance. The feedback may be presented to the user as a discrete audio-visual output responsive to the current level of proficiency for sounding the phoneme relative to the base level of proficiency.

### FIELD AND BACKGROUND

### Technical Field

The present invention relates to assessment of pronunciation of non-native language.

### Description of Related Art

A “non-native” speaker, such as someone who speaks English, for example, (or other language) as a second or third language, may face challenges of poor pronunciation, heavy accent, mistakes of stressing the wrong syllable, wrong intonation, improper rhythms and more.

In many cases, programming of the mother tongue in the brain may hinder acquisition of a foreign language. Non-native speakers often are in an environment with less access to appropriate native speaking tutors.

Thus, there is a need for and it would be advantageous to have a computerized system and method for pronunciation assessment with dynamic and adaptive personalized feedback.

### BRIEF SUMMARY

Various methods are disclosed herein for providing feedback during pronunciation assessment of a non-native language. Multiple utterances are first input to a trained machine including multiple instances of a phoneme. The instances of the phoneme are processed and a base level of proficiency is determined for sounding the phoneme. A second instance of the phoneme is input and a current level of proficiency for sounding the phoneme is determined of the second instance. Feedback is presented responsive to the current level of proficiency for sounding the phoneme relative to the base level of proficiency. Responsive to the second instance, the feedback may be presented to the user as a discrete audio-visual output responsive to the current level of proficiency for sounding the phoneme relative to the base level of proficiency. The base level proficiency for sounding the phoneme may be updated responsive to the second instance of the phoneme and feedback may be provided relative to the updated base level of proficiency. Multiple instances of multiple utterances including the phoneme may be input. Respective current levels of proficiency may be determined for sounding the phoneme responsive to the multiple instances. The base level of proficiency may be updated according to a previously defined number of most recent current levels of proficiency. Feedback to the user may be presented as an audio-visual output responsive to the current level of proficiency for sounding the phoneme relative to the updated base level of proficiency. The feedback may include a first discrete score based only on a current level of proficiency and a second discrete score responsive to the current level of proficiency for sounding the phoneme relative to the base level of proficiency.

Various computerized systems are provided herein for implementing the methods disclosed herein.

Various computer readable media are provided herein for storing instructions that when executed by a computer, cause the media to perform methods disclosed herein

### BRIEF DESCRIPTION OF THE DRAWINGS

The invention is herein described, by way of example only, with reference to the accompanying drawings, wherein:

FIG. 1A illustrates training of a machine to perform pronunciation intelligibility assessment;

FIG. 1B illustrates use of a trained machine, according to features of the present invention;

FIG. 2 illustrates a flow diagram of a method, according to features of the present invention;

FIG. 3 illustrates a data structure, according to features of the present invention;

FIG. 4 illustrates a flow diagram of a method, according to features of the present invention; and

FIG. 5 is a simplified diagram of a computer system on which embodiments of the present invention are implemented.

The foregoing and/or other aspects will become apparent from the following detailed description when considered in conjunction with the accompanying drawing figures.

### DETAILED DESCRIPTION

Reference will now be made in detail to an embodiments of the present invention, examples of which are illustrated in the accompanying drawings, wherein like reference numerals refer to the like elements throughout. The embodiments are described below to explain the present invention by referring to the figures.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, embodiments of the present invention are directed to a system and method directed to assess and improve pronunciation of a foreign language. Specifically, personalized feedback to the student may be dynamically updated as she continues to improve pronunciation, while using a computer application, according to embodiments of the present invention. The feedback may be provided as discrete scores based on an updated level of proficiency as the student demonstrates improved pronunciation.

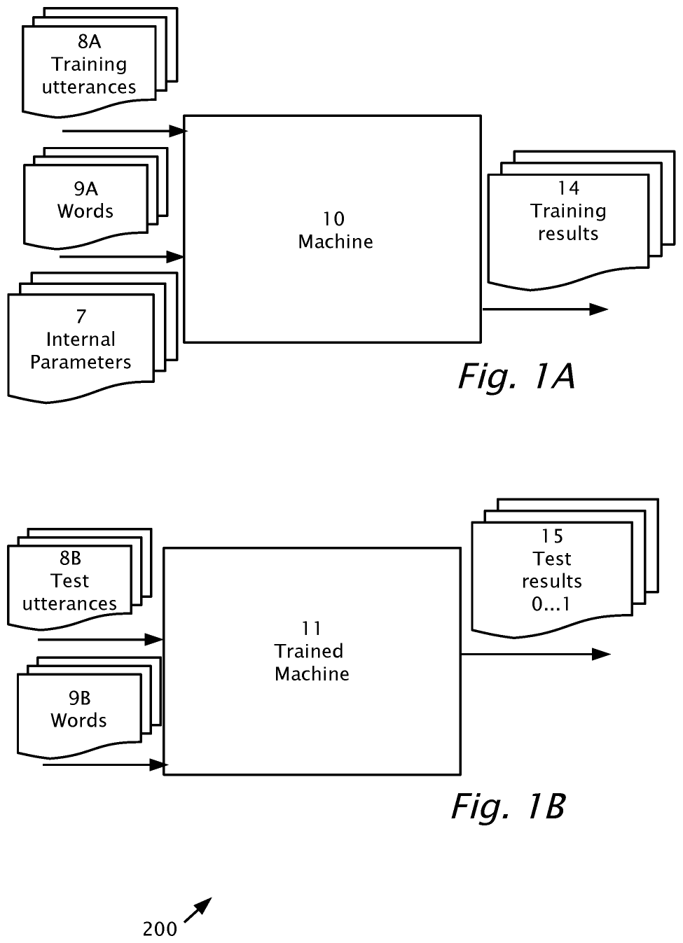

Reference is now made to FIG. 1A, illustrating a machine 10, e.g. a deep neural network (DNN) which may be trained to perform a pronunciation intelligibility assessment. Training may be performed with examples of utterances 8A of known intelligibility, which are input to a microphone, digitized and processed along with a linguistic representation 9A e.g. textual words or sentences, corresponding to utterances 8A. Machine 10 may be trained with positive examples of training utterances 8A spoken by native speakers and optionally in addition machine 10 may be trained with negative examples of training utterances 8A spoken by non-native speakers. Training of machine 10 may include adjusting internal parameters 7 of machine 10 to optimize training results 14 output from machine 10 according to respective quality of pronunciation of the expected users.

Various embodiments of the present invention involve previously training a machine, i.e. a machine learning algorithm running on a computer system, to estimate an intelligibility level for phonemes as expressed by a user. The machine learning algorithm may use a previously defined parameterized loss function which quantitatively measures success in assessing intelligibility levels of phonemes. The machine learning algorithm may internally optimize the parameters 7 of the loss function, e.g. weights and biases to minimize the loss function. During the training cycle, as the machine improves and makes fewer errors, the value of the loss function decreases. Training may include an iterative process including multiple training cycles including analyzing, e.g. manually, an output produced by the machine after a training cycle. The training utterances 8A may be adjusted, i.e. training utterances 8A may be added or removed and/or the configuration, i.e. parameters of the machine learning algorithm may be changed to optimize the training. These changes intend to improve the training cycle, cause a more rapid convergence, i.e. fewer internal iterations per training cycle and/or reduce the final value of the loss function. The training process may be considered successful when the trained machine learning algorithm, accurately assesses levels of intelligibility for multiple phonemes and for various non-native speakers of training utterances 8A.

The machine learning algorithm as presented herein may be a deep neural network (DNN) or supervised vector machine (SVM), by way of example. Many implementations may be considered, the details of which are fully and publicly disclosed. Some representative examples include:

Use of Deep Neural Network:

Spille, Constantin & Ewert, Stephan & Kollmeier, Birger & Meyer, Bernd. (2017). Predicting Speech Intelligibility with Deep Neural Networks. Computer Speech & Language. 48. 10.1016/j.cs1.2017.10.004.

Use of supervised vector machine (SVM):

Berisha V, Utianski R, Liss J. Towards A Clinical Tool For Automatic Intelligibility Assessment. Proc IEEE Int Conf Acoust Speech Signal Process. 2013:2825-2828. doi: 10.1109/ICASSP.2013.6638172. PMID: 25004985; PMCID: PMC4082827.

Reference is now made to FIG. 1B, illustrating use of a trained machine 11, according to features of the present invention. A user inputs into a microphone test utterances 8B which may be similar to training utterances 8A used for training machine 10. Test utterances 8B are digitized and processed along with corresponding words/sentences 9B which the user recites or reads. Trained machine 11 generally outputs a test result 15, a probabilistic estimation, e.g. between zero and one, which indicates intelligibility of the user's pronunciation of words/sentences 9B and/or of individual phonemes. Test results 15 may depend in various ways on the specific words/sentences 9B being tested, on the difficulty of the pronunciation of the words or phonemes and on the duration of or number of phonemes in words/sentences 9B being tested, and/or whether phonemes are added or deleted.

Test results 15 which include one or more numbers between zero and one may not be generally adequate, useful or helpful feedback to the user of trained machine 11 to enable and encourage her to improve her pronunciation of a non-native language. Aspects of the present invention are directed to converting test results 15 as received from trained machine 11 into audio and/or visual feedback to the user; the feedback based on her own previous performance in order to empower the user to improve her pronunciation of words in a non-native language.

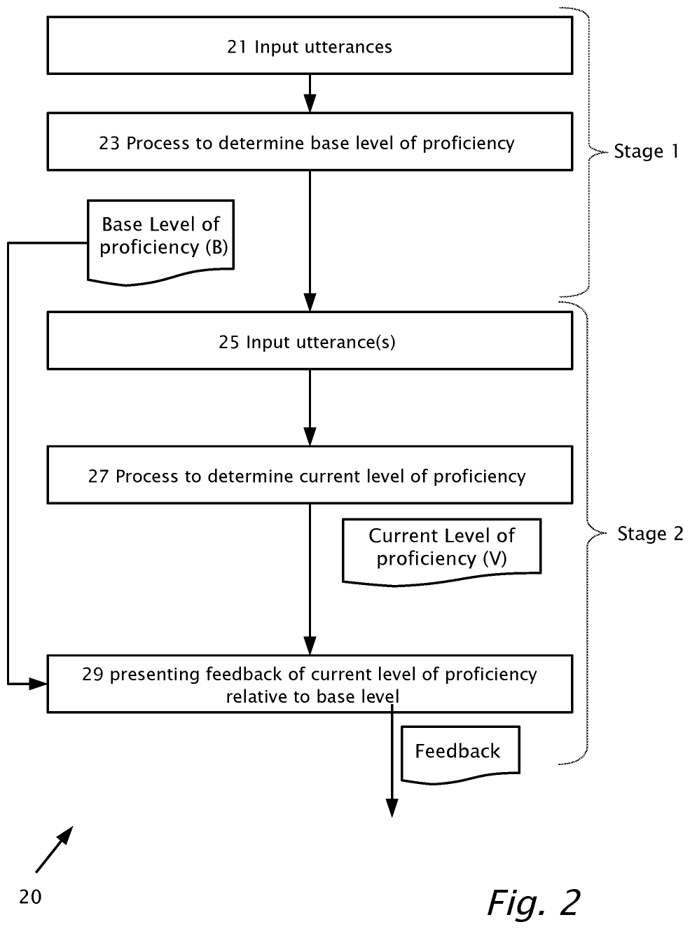

Reference is now made to FIG. 2, which illustrates a flow diagram 20 of a method for providing feedback to a user, according to features of the present invention. In stage 1, a user is requested to speak multiple utterances into a microphone optionally connected directly or over a network to trained machine 11, e.g. read or recite multiple words or sentences which are input (step 21) to trained machine 11. The words or sentences spoken include multiple, e.g. N=10 instances of a specific phoneme /R/, by way of example. The multiple N instances of phoneme /R/ are processed (step 23) to determine a base level of proficiency for sounding the phoneme /R/. A base level for sounding the phoneme /R/ may be stored. In stage 2, the user is requested to again read or recite one or more words including the phoneme /R/ and input (step 25) to trained machine 11. A current level of proficiency for sounding the phoneme /R/ may be processed (step 27) and stored. Feedback is presented (step 29) to the user responsive to the current level of proficiency for sounding phoneme /R/ relative to the base level of proficiency which was determined in stage 1.

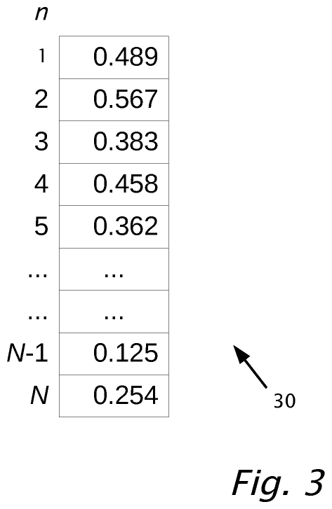

Moreover, according to a feature of the present invention, the base level of proficiency for sounding the phoneme /R/ may be dynamic and updated during stage 2 as the user continues to sound the phoneme and estimations of proficiency of sounding the phoneme are stored. Reference is now made to FIG. 3, according to features of the present invention, which illustrates an element of data storage 30, of N cells, each cell indexed by index n. Each cell may store an estimation for sounding phoneme /R/ determined after repeated test utterances 8B of a user including the phoneme /R/, by way of example. Data storage 30 may be managed as a first-in first-out stack, so that a new estimation output 0.489 from trained machine 11 is stored in stack 30 cell n=1. The estimation 0.567 previously stored in cell n=1 is pushed into cell n=2. Accordingly, the estimation stored in cell n is pushed into n+1. The estimation previously stored in cell N is no longer used or stored, so that the base proficiency level for sounding the phoneme /R/ may be updated using the most recent past N estimations.

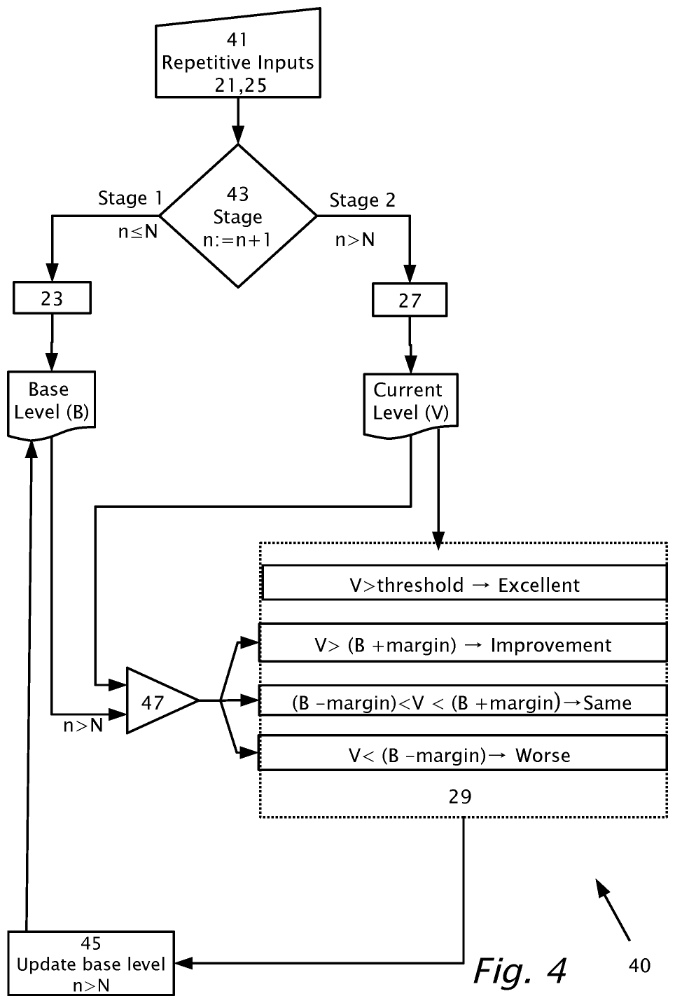

Reference is now made to FIG. 4 which illustrates a flow diagram 40 of a method according to features of the present invention, related to presenting personalized, dynamic and adaptive feedback (step 29) to the user. As previously illustrated in FIG. 2, in stage 1, a user is requested to speak multiple utterances, e.g. read or recite multiple words or sentences which are input (step 21) to a trained machine 11. The words or sentences spoken include multiple, e.g. N=10 instances of a specific phoneme /R/, by way of example. Each instance of N instances of phoneme /R/ is processed (step 23) to determine a base level of proficiency for sounding the phoneme /R/. A base level of proficiency B for sounding the phoneme /R/ may be stored based on the N instances. Subsequently, in stage 2, the user is requested to again read or recite one or more words including the phoneme /R/ and input (step 25) to trained machine 11. A current level of proficiency V for sounding the phoneme /R/ may be processed (step 27) and stored. The current level of proficiency or estimation may be compared (step 47) to the base level B of proficiency to provide (step 29) feedback to the user responsive to the current level V of proficiency for sounding phoneme /R/ relative to the base level B of proficiency. Base level of proficiency may be updated 45, by using for example estimation from N most recent utterances and data structure 30 (FIG. 3).

Four discrete scores of feedback (step 29) are shown.

An excellence threshold, e.g. 0.85 is previously determined. An absolute current level (V) of proficiency greater than 0.85 receives “Excellent” as feedback, a color dark green and/or a high pure tone, by way of example. Other scores of feedback use a comparison (step 47) between updated base level B of proficiency and current level V of proficiency based on the most recent estimation(s). A margin, e.g. +/−0.1 may be assumed. A feedback signal (step 29) indicating “Improvement”, e.g. a light green color and/or mid-range tone, may be generated if the current level V of proficiency is greater than the updated base level plus the previously determined margin.

A feedback signal (step 29) indicating “Same” or similar level, e.g. a yellow color and/or mid-range pure tone, may be generated if the current level V of proficiency is within margin of the updated base level.

A feedback signal (step 29) indicating retrogression or a “Worse” level, e.g. a red color and/or low range impure tone, may be generated if the current level V of proficiency is less than updated base level minus the margin.

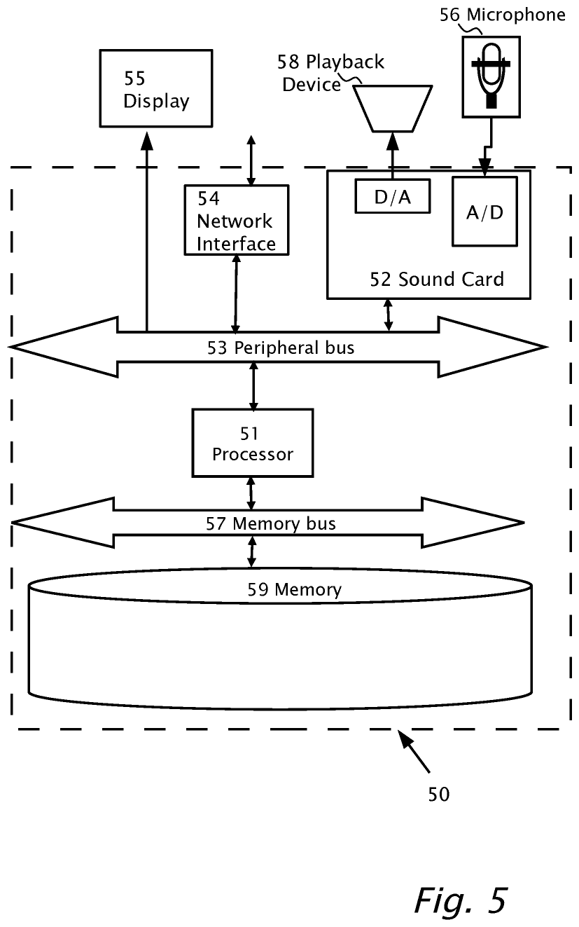

Reference in now also made to FIG. 5 which illustrates a client device 50. Client device 50 may be a computer system which includes a processor 51, connected to a peripheral bus 53 and a memory bus 57 connected to memory 59. Peripheral bus 53 operatively may connect to a display 55, a network interface 54, a sound card 52 connecting an audio input device, e.g. microphone 56 through an analog/digital converter and further connecting a playback device, e.g. speaker 58 operatively connected through a digital-to-analog D/A converter. User interface hardware may include keyboard/mouse and/or touch screen (not shown). Feedback 29 may be provided to the user

According to features of the present invention, a user may desire to improve pronunciation of certain sounds or phonemes in a language not native to the user. The user may be presented with words or sentences on display 55 which when sounded include these phonemes and requested to read, recite or otherwise sound these words. Utterances of the user may be repetitively input into microphone 56. (step 21). In stage 1 (FIGS. 2 and 4), the utterances are digitized and processed by processor 51 to determine a base level of proficiency for each phoneme being evaluated. After each utterance during the first stage, the computer may respond with audio-visual feedback, e.g. a tone, played by speaker 58 or color (light green) which may refer to one or more specific phonemes on display 55 that phonemic inputs have registered. Audio-visual feedback during stage 1 may merely encourage the user to keep sounding words being displayed and does not reflect performance of the user in sounding phonemes. At some point, a base level of proficiency for sounding phonemes being evaluated may be determined (step 23) and the system begins stage 2 during which the user continues to input utterances 25. During stage 2, the base levels of proficiency may be updated, (step 45) by using a data structure, e.g. stack as shown in FIG. 3 and current levels of proficiency are determined based on the most recent N instances of sounding respective phonemes. During stage 2, feedback 29 may be audio and/or visually presented to the user, on a phoneme by phoneme basis relative to the current level of proficiency.

Four discrete levels of feedback 29, by way of example are contemplated, the best feedback is based on an absolute level of excellence, e.g. greater than 85% compared to a level of native speakers in sounding the phoneme. Other levels of feedback may be relative to the users previous performance, the updated current levels of proficiency within a margin for error. In this way, the user may receive first repetitive feedback which indicates improvement but if the user does not attain previously defined absolute excellence then the user begins to receive feedback which shows no improvement.

The embodiments of the present invention may comprise a general-purpose or special purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general purpose or special-purpose computer system. By way of example, and not limitation, such computer-readable media can comprise physical storage media such as RAM, ROM, EPROM, flash disk, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special purpose computer system.

In this description and in the following claims, a “computer system” is defined as one or more software modules, one or more hardware modules, or combinations thereof, which work together to perform operations on data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a phone or tablet) where internal modules (such as a memory and processor) work together to perform operations on electronic data. While any computer system may be mobile, the term “mobile computer system” especially includes laptop computers, net-book computers, cellular telephones, smart-phones, wireless telephones, tablets, smart TVs, portable computers with touch sensitive screens and the like.

In this description and in the following claims, a “network” is defined as any architecture where two or more computer systems may exchange data. The term “network” may include wide area network, Internet local area network, Intranet, wireless networks such as “Wi-fi”, virtual private networks, mobile access network using access point name (APN) and Internet. Exchanged data may be in the form of electrical signals that are meaningful to the two or more computer systems. When data is transferred or provided over a network or another communications connection (either hard wired, wireless, or a combination of hard wired or wireless) to a computer system or computer device, the connection is properly viewed as a computer-readable medium. Thus, any such connection is properly termed a computer-readable medium. Combinations of the above should also be included within the scope of computer-readable media. Thus, computer readable media as disclosed herein may be transitory or non-transitory. Computer-executable instructions comprise, for example, instructions and data which cause a general-purpose computer system or special purpose computer system to perform a certain function or group of functions.

The term “server” as used herein, refers to a computer system including a processor, data storage and a network adapter generally configured to provide a service over the computer network. A computer system which receives a service provided by the server may be known as a “client” computer system.

The term “corresponding” as used herein refers to a correspondence between a linguistic transcription, e.g. textual word and an utterance or sounding of that textual word.

The term “phoneme” as used herein is a speech sound that, in a given language, if it were swapped with another phoneme, would change the meaning of the word.

The term “utterance” as used herein is a unit of speech preceded and followed by silence. An utterance includes one or more phonemes.

The term “audio-visual” refers to audio and/or visual and may include different colors or tones, by way of example.

The term “continuous” as used herein refers to continuous data such as estimations in the interval between zero and one output from a probabilistic estimator (trained machine 11), by way of example.

The term “discrete” as used herein refers to data or scores which may have specific values and are non-continuous such as “Excellent”, “Improvement”, “Same”, “Worse” or the audio-visual representations thereof.

The term “sounding” as used herein refers to proficiency of sounding non-native speech and may include but are not limited to the following aspects of speech:

Pronunciation: Pronunciation refers to the way a word is spoken. Pronunciation may be assessed on a phonemic level. Minematsu, Nobuaki. “Pronunciation assessment based upon the phonological distortions observed in language learners' utterances.” Interspeech, 2004.

Word Stress: Stress or accent is relative emphasis or prominence given to a certain syllable in a word. Juan Pablo Arias, Nestor Becerra Yoma, Hiram Vivanco “Word stress assessment for computer aided language learning”, Interspeech, 2009.

Intonation Assessment: Intonation is variation of spoken pitch, which does not distinguish words but indicates attitudes and/or emotion of the speaker. Arias, Juan Pablo, Nestor Becerra Yoma, and Hiram Vivanco. “Automatic intonation assessment for computer aided language learning” Speech communication 52.3 (2010): 254-267.

Loudness Assessment: Loudness is a fundamental element of sound perception. Many of the factors contributing to loudness are well understood. The most prominent factor is the sound pressure level, but also the frequency content and duration of the sound influence the loudness. Skovenborg, Esben, René Quesnel, and Soren H. Nielsen. “Loudness assessment of music and speech.” Audio Engineering Society Convention 116. Audio Engineering Society, 2004.

Pitch: In speech, the relative highness or lowness of a tone as perceived by the ear, which depends on the number of vibrations per second produced by the vocal cords. Pitch is the main acoustic correlate of tone and intonation.

Rhythm and Tempo: Rhythm and tempo as in music refers to how quickly the user is speaking. Cucchiarini, Catia, Helmer Strik, and Lou Boves. “Quantitative assessment of second language learners' fluency by means of automatic speech recognition technology.” The Journal of the Acoustical Society of America 107.2 (2000): 989-999.

Timbre: Timbre is speech refers to the tonal distribution above the fundamental pitch.

Pauses refer to silent time periods between words.

Filler: Filler refers to sounds which are spoken between recognizable words. “Word spotting using both filler and phone recognition.” U.S. Pat. No. 5,950,159.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

The articles “a”, “an” is used herein, such as “a data structure”, “an utterance”, have the meaning of “one or more” that is “one or more data structures” and “one or more utterances”

The term “non-native” is used herein refers to a person attempting to learn another language which is not his/her mother tongue or native-language.

The term “EFL” or “English as a foreign language” as used herein refers to a person attempting to learn another language when his/her first language is English.

The terms “user” and “speaker” are used herein interchangeably.

The present application is gender neutral and personal pronouns ‘he’ and ‘she’ are used herein interchangeably.

Although selected features of the present invention have been shown and described, it is to be understood the present invention is not limited to the described features.

While the invention has been described with respect to a limited number of embodiments, it will be appreciated that many variations, modifications and other applications of the invention may be made.

1. A method comprising:
first inputting to a trained machine a plurality of utterances including a plurality of instances of a phoneme;
processing the instances of the phoneme and determining a base level of proficiency for sounding the phoneme;
second inputting a second instance of the phoneme and determining a current level of proficiency for sounding the phoneme of the second instance; and
presenting feedback responsive to the current level of proficiency for sounding the phoneme relative to the base level of proficiency.

2. The method of claim 1, further comprising:
responsive to the second inputting, presenting feedback to the user as a discrete audio-visual output responsive to the current level of proficiency for sounding the phoneme relative to the base level of proficiency.

3. The method of claim 1, further comprising:
updating the base level proficiency for sounding the phoneme responsive to the second instance of the phoneme; and
providing feedback relative to the updated base level of proficiency.

4. The method of claim 3, further comprising:
third inputting of a plurality of utterances including the phoneme;
determining respective current levels of proficiency for sounding the phoneme responsive to the third inputting;
updating the base level of proficiency according to a previously defined number of most recent current levels of proficiency.

5. The method of claim 4, further comprising:
responsive to the third inputting, presenting feedback to the user as an audio-visual output responsive to the current level of proficiency for sounding the phoneme relative to the updated base level of proficiency.

6. The method of claim 1, wherein the feedback includes:
a first discrete score based only on a current level of proficiency, and
a second discrete score responsive to the current level of proficiency for sounding the phoneme relative to the base level of proficiency.

7. A computer readable medium storing instructions that when executed by a computer, cause the computer readable medium to perform a method comprising:
first inputting to a trained machine a plurality of utterances including a plurality of instances of a phoneme;
processing the instances of the phoneme and determining a base level of proficiency for sounding the phoneme;
second inputting a second instance of the phoneme and determining a current level of proficiency for sounding the phoneme of the second instance; and
presenting feedback responsive to the current level of proficiency for sounding the phoneme relative to the base level of proficiency.

8. The computer readable medium of claim 7, further storing instructions that when executed by a computer, cause the computer readable medium to perform further method steps comprising;
updating the base level proficiency for sounding the phoneme responsive to the second instance of the phoneme; and
providing feedback relative to the updated base level of proficiency.

9. The computer readable medium of claim 7, further storing instructions that when executed by a computer, cause the computer readable medium to perform a further method step comprising:
responsive to the second inputting, presenting the feedback to the user as a discrete audio-visual output responsive to the current level of proficiency for sounding the phoneme relative to the base level of proficiency.

10. The computer readable medium of claim 8, further storing instructions that when executed by a computer, cause the computer readable medium to perform further method steps comprising:
third inputting of a plurality of utterances including the phoneme;
determining respective current levels of proficiency for sounding the phoneme responsive to the third inputting;
updating the base level of proficiency according to a previously defined number of most recent current levels of proficiency.

11. The computer readable medium of claim 10, further storing instructions that when executed by a computer, cause the computer readable medium to perform a further method step comprising:
responsive to the third inputting, presenting feedback to the user as an audio-visual output responsive to the current level of proficiency for sounding the phoneme relative to the updated base level of proficiency.

12. The computer readable medium of claim 7, wherein the feedback includes:
a first discrete score based only on a current level of proficiency, and
a second discrete score responsive to the current level of proficiency for sounding the phoneme relative to the base level of proficiency.

13. A system configured to:
first input to a trained machine a plurality of utterances including a plurality of instances of a phoneme;
process the instances of the phoneme and determining a base level of proficiency for sounding the phoneme;
second input a second instance of the phoneme and determining a current level of proficiency for sounding the phoneme of the second instance; and
present feedback responsive to the current level of proficiency for sounding the phoneme relative to the base level of proficiency.

14. The system of claim 13, further configured to:
update the base level proficiency for sounding the phoneme responsive to the second instance of the phoneme and provide the feedback relative to the updated base level of proficiency.

15. The system of claim 13, further configured to:
responsive to the second input, present the feedback to the user as a discrete audio-visual output responsive to the current level of proficiency for sounding the phoneme relative to the base level of proficiency.

16. The system of claim 13, further configured to:
third input of a plurality of utterances including the phoneme;
determine respective current levels of proficiency for sounding the phoneme responsive to the third input;
update the base level of proficiency according to a previously defined number of most recent current levels of proficiency.

17. The system of claim 16, further configured to:
responsive to the third input, presenting the feedback to the user as an audio-visual output responsive to the current level of proficiency for sounding the phoneme relative to the updated base level of proficiency.

18. The system of claim 13, wherein the feedback includes:
a first discrete score based only on a current level of proficiency, and
a second discrete score responsive to the current level of proficiency for sounding the phoneme relative to the base level of proficiency.
